(19) United States
(12) Patent Application Publication
(10) Pub. No.: US 2006/0048224 A1
(43) Pub. Date: Mar. 2, 2006

(54) Method and apparatus for automatically detecting sensitive information, applying policies based on a structured taxonomy and dynamically enforcing and reporting on the protection of sensitive data through a software permission wrapper

(75) Inventors: Daivid Paul Duncan, Broomfield, CO (US); Daivd Alan Myers, Broomfield, CO (US)

Correspondence Address: J. Henry Muetterties, 7796 S. Datura Street, Littleton, CO, 80120, US

(73) Assignee: encryptX Corporation, Boulder, CO (US)

(21) Appl. No.: 10/930,173

(22) Filed: Aug. 30, 2004

(51) Int. Cl. G06F 12/14

(52) U.S. Cl. 726/22

(57) ABSTRACT

The present invention relates to the automatic detection of sensitive digital information, and the identification methods, application and enforcement of information security policies for digital information controlled through a software permission wrapper throughout the useful life of the information. This invention includes a unique taxonomy that defines the policies and rules regarding how the information is controlled automatically throughout its useful lifecycle based on the type of information, the stage of the information lifecycle, the user/group role accessing the information, the locality of the information, and the expected threats to the information. The taxonomy is maintained in a database that associates information security control policies and actions to sensitive data. These policies are enforced through a software permission wrapper that is used to encapsulate sensitive digital information. The software permission wrapper is used to control access and enforce digital rights to the information based on the taxonomy based policies for that information. The permission wrapper can automatically change the protection of the information based on pre-defined protection states that can automatically enforce discretionary access control rights to the sensitive information controlled in the permission wrapper. The changes to the level of protection occur dynamically based on changes in user locality, stage of information lifecycle, and user/group role and the detection of threats. In addition, there is provided an internal audit capability describing what actions the user has performed, where the data is located, with whom and how the data has been shared.

### RELATED APPLICATION DATA

This application is related to Applicant's patent application entitled DATA RIGHTS MANAGEMENT OF DIGITAL INFORMATION IN A PORTABLE SOFTWARE PERMISSION WRAPPER, U.S. Ser. No. 10/718,417 filed on Nov. 20, 2003, which is incorporated herein by reference in its entirety.

### FIELD OF THE INVENTION

The present invention relates to the field of distribution, access and use of digital information, and in particular with identifying, locating and controlling the distribution and use of the digital information.

### BACKGROUND OF THE INVENTION

This application relates generally to the protection of sensitive digital information and more specifically to the enforcement of usage rights based on the user/group role, stage of information lifecycle, locality and threats.

Digital data creates an inherent information security problem. Since digital data is portable it is easy to lose control over the information. Since digital data is distributed among many users, PCs, server and storage devices, may copies may exist. Digital data has a usage lifecycle in which the protection requirements change based on: the current version versus older versions of the information, the user/group role regarding their rights to access that information, the locality or usage environment that applies to where the data is used and on which device, and a threat factor that may be explicit or implicit and that is to some extent based on these combination of factors.

The first major problem associated with protecting sensitive digital information is that it is inherently portable. Securing sensitive data is a significant problem for most corporate users because data, in digital form, is easy to share copy and save in an uncontrolled manner. Since digital information is by design portable this contributes to the ease of which the information can be lost, stolen or misused. The loss of sensitive digital information is often purely accidental; a user forgets to protect sensitive data when sharing with other “trusted” users, who in turn share with other users that may be considered “un-trusted.” Occasionally, the loss is malicious; a user intentionally circumvents the security policy and makes a copy for their own personal use (e.g. when switching jobs), or the data is stolen outright (e.g. an external hacker breaks into the user's data files on their PC or the PC is stolen).

The second major problem associated with protecting sensitive digital information is that the data protection requirements change over the information lifecycle. Business data has a lifecycle that spans from the creation phase through to the end of life of that information. The protection requirements naturally change as sensitive digital information moves from a current, or fresh state, to a less active, or archive state.

Sensitive digital information corresponds to a dynamic information lifecycle. In the first stage, called the Creation Phase, a document is created. During the creation phase the sensitive digital information (e.g. a document) is in draft form, is sensitive and must be protected and controlled on the author's computing device. This protection may be through a password mechanism, by encrypting the data, or a combination of the two. During this stage the need to protect the data is very high since it is fresh, sensitive digital information.

Once the digital document is complete it is typically electronically distributed to recipients for review. This phase is the Electronic Distribution Phase. In the vast majority of cases, the distribution is conducted through email. If the file is too large for email, digital information may be saved or FTP'd to a file server; which the recipient may access to download the information. Or, the file may be burned to a CD, DVD or Zip drive and subsequently sent to the recipient through physical mail.

During the Electronic Distribution Phase, the information could be stolen by hackers that are sniffing the Internet for email traffic. Or, the physical mail (CD, DVD) or download of the data (from an FTP server) could also be compromised. During the Electronic Distribution Phase, the data is at its most susceptible to external threats and therefore must also be protected.

The next phase is associated with the review and collaboration on the document; reviewers or recipients of the information typically make a local copy of the document, review, modify, delete and then send a copy of the changed document back to the author. Typically they save/store both the original copy of the document as well as their changed version on their local PC or storage device. During this Review and Collaboration Phase sensitive digital information often is unprotected. This is because reviewers may not perceive the document to be sensitive and will in-turn make local, uncontrolled copies. Or in the haste to provide feedback, may re-distribute the document back to the author using insecure methods (e.g. generic email).

During the Review and Collaboration Phase it is extremely difficult to ensure protection because the sensitive digital information (e.g. document) is frequently changing and therefore multiple versions are propagated. Individuals involved in the collaboration process often forget to protect the document or protect in an inconsistent fashion (e.g. some reviewers protect the data and others do not). The problem is also compounded in that a number of security technologies may have to be used, in combination, to provide comprehensive protection of the data (e.g. SSL encryption combined with local hard drive encryption, and PKI for sharing through email) during this phase. Since the application of these security technologies often makes collaboration and communication more time consuming and difficult (e.g. having to establish PKI certificates among all users sharing content with each other), users typically reject the use of security technology altogether; contributing to the possibility that the data will be lost or compromised.

The next phase corresponds to the publication and usage of the digital document; the Publication and Usage Phase. Once the document is complete it is typically published to a wide range of users with different roles inside and outside of the organization. These roles typically correspond to the usage rights associated with the information. Some users may be able to view the digital document as reference material, such as when constructing a supporting document. Other users may have complete local access to the information on their PC and may be able to cut and paste from the original digital document into other files, or store a local copy on their PC hard drive. Users may be both internal and external to the organization; employees, channel partners, marketing agencies, outsourced engineering firms, etc., may all be provided with an electronic copy of the business plan.

During the Publication and Usage Phase the digital document remains highly sensitive and is typically associated with a period of time in which the information is considered current. Time period and frequency of use become key factors in determining the need for protection. Current information that is often accessed requires strong security protection. As the digital document receives wider distribution amongst many users, many of the same security protection issues are encountered again; protection during electronic distribution and a lack of control over the information when in use on a recipient's PC or file server.

When the digital document becomes out of date with the current business cycle it is typically replaced. The prior version is used as a reference and is accessed on a sporadic basis. This phase is called the Reference Phase. The information may still be sensitive but the perceived degree of sensitivity has lessened; the document is not current to the new business cycle. During the Reference Phase the information protection requirement is often lessened based on the original creation or publication date, when compared to the current date. An example of this using security classification terminology is the regular downgrade by the US Government of sensitive information from “Secret” to “Public Disclosure” after a predefined number of years.

When the sensitive digital document has ceased to be useful it is often archived for historical purposes. This is called the Archival Phase. Systems Administrators typically remove old, out of date digital information from local file servers and archive the data on to low cost storage (e.g. tape) devices. Information in archival form is often declassified with no protection, or minimal protection (e.g. password only) since it has aged beyond the current business cycle. However, in corporate environments where automated backup software is used, sensitive digital information is replicated on to archival devices for business continuity and disaster recovery purposes. During this phase the data is still in the current business cycle phase of use and is highly sensitive. Systems Administrators often do not have an understanding of the unique security protection requirements for the information; merely that it needs to be backed up since it is current sensitive information. Correspondingly, both old and current sensitive business information are often intermingled on the same archival devices with no unique differentiation regarding how the information is protected from a security perspective.

How sensitive information is used during the information lifecycle creates a third major problem associated with protecting sensitive digital information; proliferation of multiple copies and versions on multiple user devices. For each copy of the document sent to a reviewer we can assume that at this point we have effectively doubled the number of plans times the number of reviewers that the user stores locally on their machine. And as each subsequent update and review cycle occurs, we typically will find many different versions of the document, all with different review dates and corresponding changes stored on the reviewers PC. There may also be many corresponding backups of that document on archival devices; backups of the author files as well as the many corresponding reviewer files. In summary, many copies of the sensitive document are distributed across a number of users, and many versions of that sensitive document may also exist with those users.

The sensitivity of the information and the corresponding protection requirements change over the course of the information lifecycle; moving from highly sensitive when first created and shared, to less sensitive when slightly out of date and used as reference material, to not sensitive or merely confidential when at the end of its lifecycle. The need to understand where the information is in the information lifecycle is essential to ensure a sensitive document in digital form is appropriately protected, and is not over-protected if it is now out of date.

A fourth major problem regarding sensitive information is that the protection requirements for sensitive digital information also change based on “locality.” Locality corresponds to the device, network and physical environment in which someone accesses the sensitive information. As an example, if a user is working with sensitive digital information in the office, on their PC, logged in to the corporate network that is protected from outside hackers by a firewall, the information may only need to be password protected. However, if the user has stored the document locally on their laptop and is working with the information at a customer site, on a plane, or in a hotel room, the locality corresponds to greater risk; an environment that has a perceived higher risk that the data could be lost or stolen.

A fifth major problem regarding protection of sensitive information is that there are multiple user/group roles and these roles may be overlapping or specifically assigned to the document. Each user corresponds to a role; executives, managers, individual contributors, partners, suppliers, etc. The role is also associated with the group that the user is a member of. Groups may include Executive, Marketing, Sales, Engineering, IT, Accounting, etc. Each Group is understood to have an explicit set of security permissions regarding the access and use of sensitive information created and distributed from within their group. These permissions change based on the content that the group receives from other groups; finance may allow marketing to review financials but not have the ability to update or change them within a business plan.

Within the group, the user role also determines the sub-set of permissions that the user is granted within the overall group permissions set when accessing sensitive business information. The user role provides additional security discrimination regarding what the individual is allowed to do with sensitive data within that group. Further complicating this issue is that users may have multiple roles (e.g. Author versus Reviewer) and therefore may have different rights to sensitive information based on their role and the direct relationship their role has to sensitive information.

The sixth major problem is that the protection requirements for sensitive digital information are also to some extent based on the version of the document. It is not always true that an older version is not sensitive; older or draft versions may contain a great deal of sensitive business information albeit in raw form. However, it is typically the case that the final version of a document is the most sensitive as it contains the final thoughts, strategies and information that the company has compiled (e.g. pricing lists, competitive information, marketing tactics, engineering architecture information, patent strategies, etc.) for the current business cycle. A key issue therefore in ensuring data protection is to ensure that older versions are consolidated or deleted to reduce the risk of sensitive information propagation and loss.

The seventh major problem regarding the protection of sensitive digital information is simply finding it. Because sensitive digital information is portable, is shared, proliferates, or stored differently during the information lifecycle and is reviewed and collaborated on, the data exists on a number of user devices. A key issue in the field of information security is how to find sensitive digital information and how to automatically protect in place, and or migrate the data to consolidated secure file servers and devices.

The final major problem regarding the protection of sensitive digital information is how to protect the information in response to threats. How the protection mechanism is invoked is to a large extent based on threats—externally reported, assumed and internally detected. If a user is accessing sensitive corporate data on a file server that is part of a corporate network segment under attack from an external hacker, the threat is real and the need to enhance the protection of that data is essential. These types of threats are typically reported from other security platforms (e.g. Intrusion Detection Systems). However, they typically have only a manual correlation to the systems and software used to protect the underlying data stored on the network. Systems Administrators typically must take manual action to power-off or disable external access to file servers that are on network segments under attack.

Threats can also be assumed—certain environments have a correspondingly higher risk. As an example, working on your laptop and checking your email in an Airport while connected to an unprotected wireless network can expose the entire contents of the laptop hard drive to theft.

Finally, threats can be internally detected. User attempts to circumvent information security policy such as by attempting to share sensitive digital information in an uncontrolled fashion, or copy the information in the clear can be determined. If the user has not been granted these explicit permissions the security protection requirements must adapt to meet this internal “trusted user” threat.

### SUMMARY OF THE INVENTION

It is a primary objective of the invention to automatically find and protect sensitive digital information with dynamic protection states that correspond to the various stages of the information lifecycle. A first aspect of the information is related to how protection policies are determined using a specific taxonomy drive approach that uses information regarding the stage of information lifecycle, the locality, the user/group role and known threats. A second aspect of the invention is how the protection mechanism used to encapsulate sensitive information and called a software permission wrapper, can enforce these policies dynamically and independently throughout the information lifecycle. A third aspect of the invention is how the software permission wrapper can determine that numerous versions of sensitive information exist, and can consolidate and provide version control to reduce proliferation of sensitive information. The fourth aspect of the invention is related to how digital information is scanned to determine if sensitive information is contained therein. A fifth aspect of the invention is how the software permission wrapper can invoke predefined protection states based on a reported or determined threat information. The sixth and final aspect of the information is how the software permission wrapper can report user actions and activities to an administrative console and how this in-turn is used to provide text and visual based reports regarding the locations, distribution and usage patterns of sensitive information within and outside of an organization.

The protection mechanism includes the ability to automatically and dynamically change the protection on the data based on the user locality, stage of information lifecycle, locality, user group/role and The present invention describes a unique method of how data protection policies are derived using a number of factors including stage of information lifecycle, user/group role, locality and threats. This method corresponds to how the enforcement mechanism protects the sensitive information.

The present invention describes the methods by which data protection policies are enforced in an independent, portable software permission wrapper. The permission wrapper provides manual and automatic enforcement of data protection rules that allow the content provider (administrator) or corporation to control what the recipient (user) can do with sensitive digital information; such as making the information read only, add, delete, modify, share with other users and the period of time in which the persistent content (digital information) can be accessed by the users.

The permission control wrapper is used to encrypt and encapsulate digital information for the purpose of enforcing discretionary access control rights to the data contained in the wrapper. The permission control wrapper enforces rules associated with users, and their rights to access the data. Those rights are based on deterministic security behavior of the permission wrapper based on embedded security policies and rules contained therein and that are based, in part, on the user type, network connectivity state, and the user environment in which the data is accessed.

### BRIEF DESCRIPTION OF THE DRAWINGS

The invention will be described through a preferred embodiment and the attached drawings in which:

FIG. 1 is a diagram showing the information lifecycle and the corresponding changes in the need for digital rights management protection during the lifecycle.

FIG. 2 is a diagram that depicts the software permission wrapper and the various elements in the permission wrapper that control and internally track access to data.

FIG. 3 is a diagram that shows the elements of user locality and how these affect the information security policy.

FIG. 4 is a diagram that shows the pre-defined protection states that are enabled in the software permission wrapper and how these protection states can be invoked automatically or dynamically by the software permission wrapper to modify the protection of the encapsulated data.

FIG. 5 is a diagram that shows how audit information is polled from the software permission wrapper, and aggregated at a central audit server for text and graphics based reporting.

FIG. 6 is a diagram depicting the analysis of sensitive information when transmitted, and how a software scanning engine performs analysis, decomposition, extraction, lexical analysis, and parsing to understand keywords, phrases and the context of the information to determine if sensitive information exists and what actions to perform, such as wrap in a permission wrapper.

FIG. 7 is a diagram that shows how abstract document signature analysis can determine document types and associate document types with information security protection policies.

### DETAILED DESCRIPTION OF THE INVENTION

The first major aspect of the invention relates to how protection policies are determined for sensitive digital information using a specific taxonomy drive approach that uses information regarding the stage of information lifecycle, the locality, the user/group role and known threats.

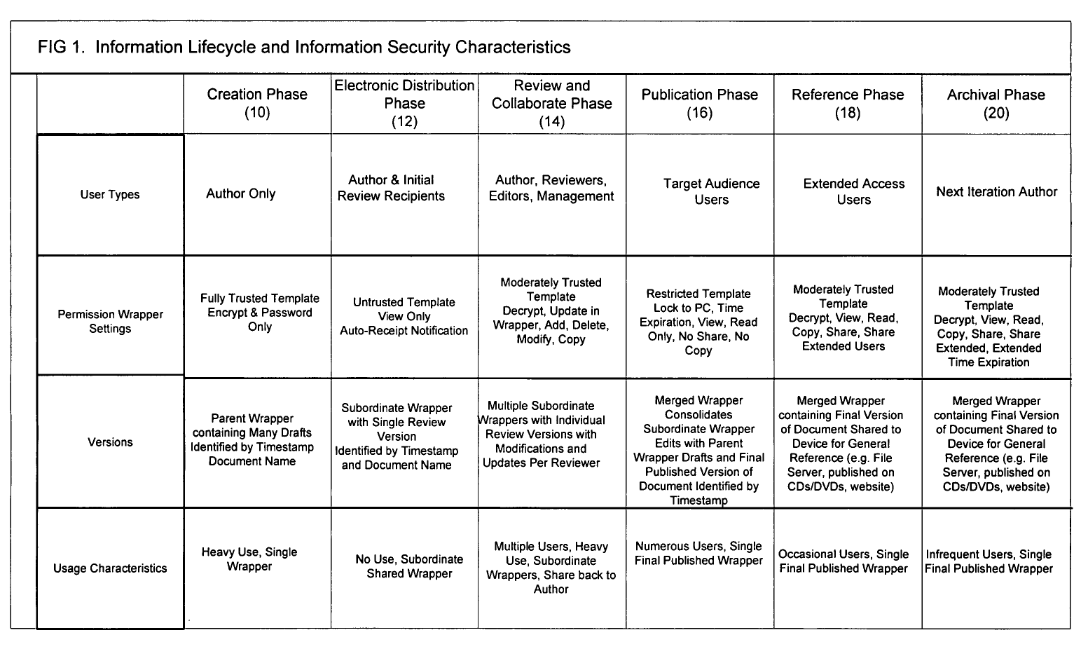

FIG. 1 shows the stages or phases of the information lifecycle: Creation 10, Electronic Distribution 12, Review and Collaborate 14, Publication 16, Reference 18 and Archival 20, the usage characteristics for digital information in the lifecycle and the corresponding implications regarding the number of users, versions and data security protection modes required during each phase of the lifecycle.

In the Creation Stage 10 depicted in FIG. 1 of the information lifecycle, the number of users that have access to the data is very small and is typically only the author of the information. The digital information is very dynamic, frequently changing as the author develops the information.

Many versions are created and stored locally on the user host PC. Copies may be stored on a central server, used to backup the copy on the host PC. The author user/group role is associated with an Administrator level—having full control over the data, which users the data will be shared with and how the data will be shared.

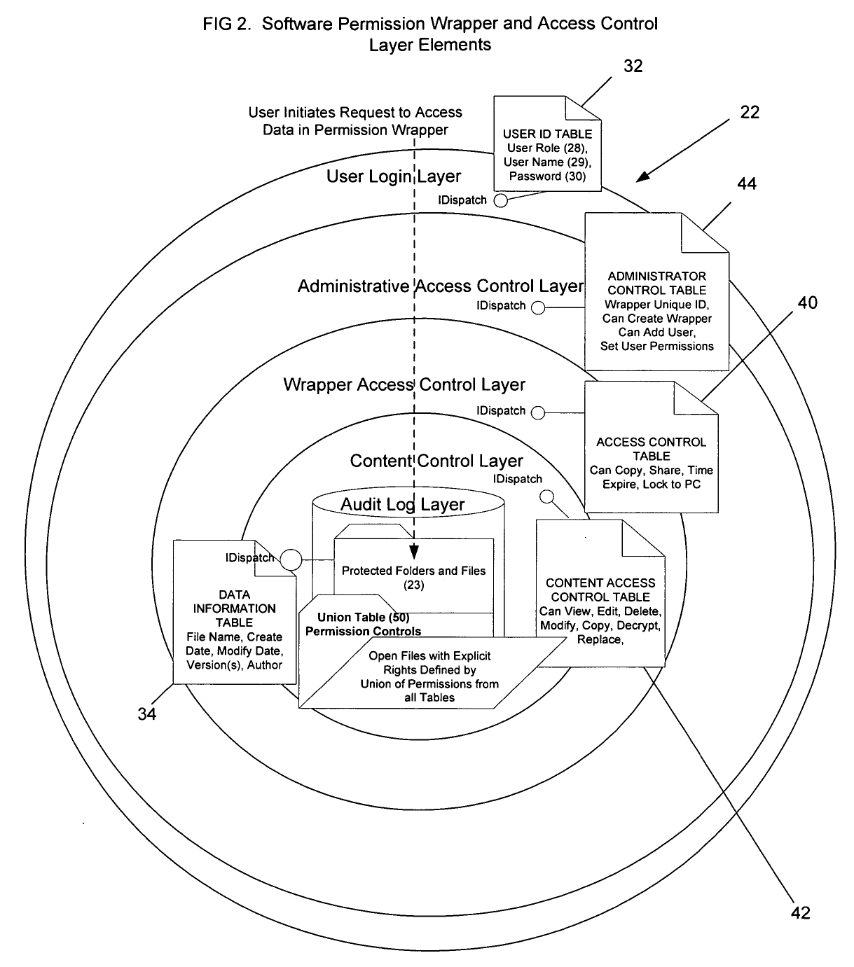

The first aspect of the invention uses embedded logic in a software permission wrapper 22 to understand automatically that the information is in the Creation Phase 10. This system logic creates a unique index table record 50 for each file 24 stored therein that tracks first creation, store, open and writing access in the permission wrapper 22. Corresponding to this index table record 50 are a series of embedded access control rules that further define what stage of the information lifecycle the data is in. It is the creation of an index table record for a file, and the various access control settings for that file that allow the permission wrapper 22 to determine the relevant stage of the information lifecycle. Information about the permission wrapper index table record 50 is shown in FIG. 2.

First actions on sensitive data 23 controlled in a permission control wrapper 22 are associated with the user 26 that created the data, content or information 23 in the permission wrapper 22. In the Creation Phase 10, the content or data 23 is initially added to the permission wrapper 22. Often, only a single user 26, typically the author, has access to the information and the data is typically only password controlled. The author of the information typically will not set explicit permissions on him or herself restricting access. Rather the author or owner of the data will have full access to the information.

Information about the initial user 26 that has created the permission wrapper 22 and added content 23 to is stored in a separate access control record embedded in the permission wrapper 22, shown in FIG. 2, and the corresponding digital rights for that user 26—which are typically at the highest level—or Administrative level. Users 26 that have created and have full administrative access to the information are listed as the “originator” of the information 23. The two index table records containing the user information (User ID Table 32) and the data information table 34 are joined in the embedded system logic providing a corresponding association between the originator of the information and the initial creation of the information to determine the author of the information. It is the combination of newly formed or added data to the permission wrapper 22 and an Administrative user access level that corresponds to the internal system logic that understands that the information is in the Creation Phase 10. As subsequent user operations are performed related to various stages in the information lifecycle, the system logs these operations, updates the index table records 50 and the access control table, to automatically determine what stage of the information lifecycle the information 23 is associated with.

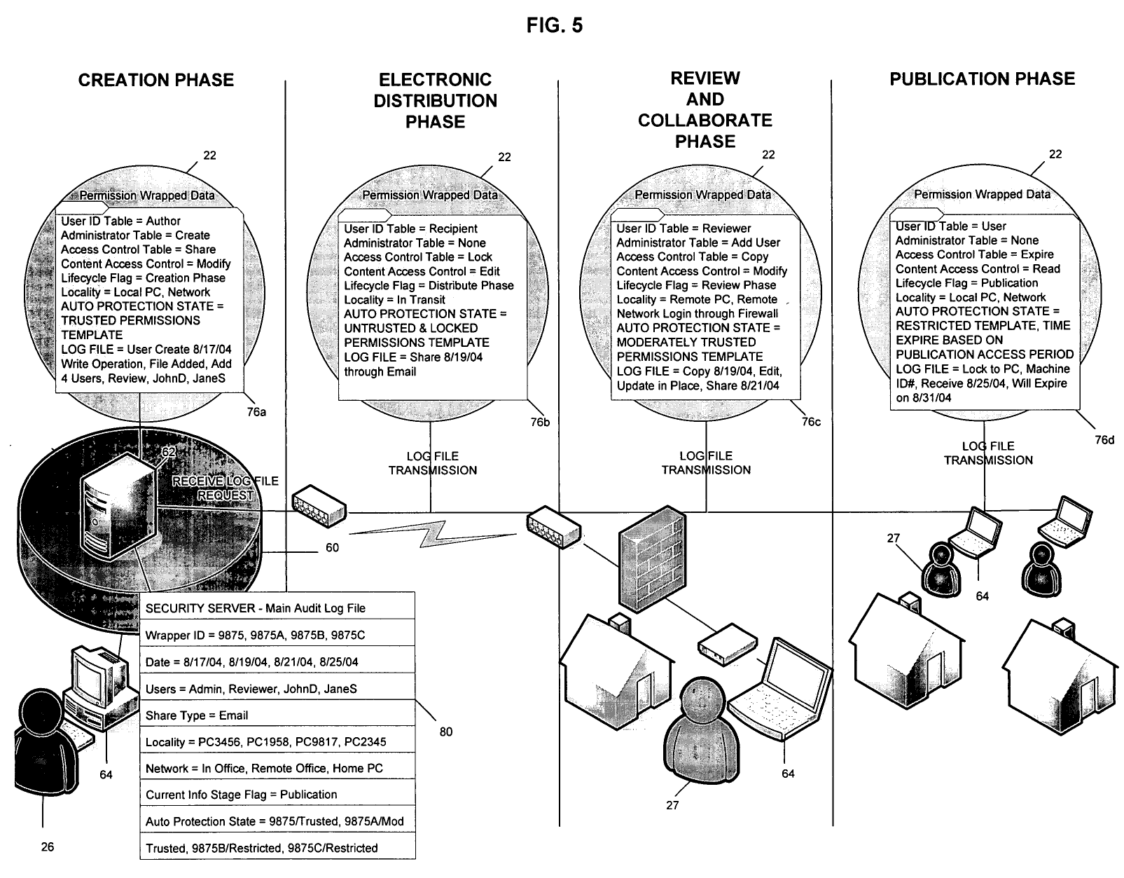

Permission wrapper 22 operations that are associated with the Electronic Distribution Phase 12 for permission wrapped digital information include: add new users, associate additional user permissions and explicit data sharing operations. Each time the content is shared from the Author's originating permission wrapper 22, an additional record is created in the index that shows the Administrative user that performed the action, the additional users added to the permission wrapper 22 by that Administrative user 26, and the explicit date, time, and method of the sharing operation—such as email, ftp, copy, and save as. Each corresponding share of the data 23 from the permission wrapper 22 to external users 27a, 27b, 27c, . . . creates a subordinate permission wrapper 22′ that has embedded a unique identifier 36 (shown in FIG. 5). This identifier 36 associates the shared permission wrapped data with the original permission wrapper 22 from which the share was created. The creation of subordinate permission wrappers 22′ further identifies that the protected information is in the Electronic Distribution Phase 12.

A key aspect of the invention is the creation and usage of unique identifiers 36 for each permission wrapped set of data that contains parent/child information used to track and understand where shared digital information is located, the users 26 or 27 that have access to it, and their usage actions on the data 23. The operations are most typically performed during the Electronic Distribution Phase 12. The subsequent merging of content 23″ in subordinate permission wrappers 22″ into the parent wrapper 22 is indicative that the sensitive information is associated with the Review and Collaboration Phases 14.

Access to the file 24 and directory 25 contents of the permission wrapped data is associated with individual users 26 or 27 and the corresponding groups/roles as shown in FIG. 2. Users 26 or 27 are identified by a user name 29 and password 30 combination that corresponds to their role 28 and usage rights in the access control table 40 and three unique and corresponding sets of access control rights. Understanding how users are added to the permission wrapper 22, and the access control rights granted to those users directly corresponds to internal system logic that understands where the digital information is in the different phases of the information lifecycle.

Three basic types of access control rights are embodied in the internal system logic of the permission wrapper for each user as shown in FIG. 2. These rights, called rules, in the internal system logic are Wrapper Access Control 40, Content Access Control 42, and Administrative Access Control 44. Each rule set is used in combination to determine the explicit permissions each user is granted when accessing content 23 in the permission wrapper 22. Each rule can be applied to the permission wrapper 22 as a whole, to directories 25 within the wrapper, and to individual files 24 within a permission wrapper 22.

The first set of rules—Wrapper Access Control 40—include Can Copy Wrapper 40a, Can Share Wrapper 40b, Time Expiration 40c, and Lock Wrapper 40d. Can Copy Wrapper 40a rules either allows or disallows copying operations of the permission wrapper to other computing devices. Can Share 40b rules determine if the wrapper contents 23 can be shared with external users. Time Expiration 40c rules determine how long the contents 23 of the permission wrapper 22 may be accessed before access is revoked. The Lock Wrapper 40d rule provides a unique binding mechanism that associates the permission wrapper 22 with unique information about the host PC. The unique information is joined with the Wrapper Access Control 40 rule. Each time the wrapper is opened, if the corresponding unique information is not found, the permission wrapper 22 and its contents 23 cannot be used.

Wrapper Access Control 40rule settings are most often set just prior to the transmission of data during the Electronic Distribution Phase 12, as shown in FIG. 1. These settings determine, in general, what users can do with the permission wrapper 22, in the aggregate, prior to sharing the information. More stringent settings of Wrapper Access Control rules occur during the early stages of the information lifecycle. Less stringent settings are associated with sensitive digital information in the Reference and Archival phases, 18 and 20 respectively.

The second set of rules—Content Access Control 42—as shown in FIG. 2, explicitly controls access to individual directories 25 and files 24 of digital information in the permission wrapper 22. Content Specific Access Control 40 rules determine the way in which a user 26 or 27 can manipulate the digital content 23 stored in a permission wrapper 22. The primary rules supported by the permission wrapper include: Can View 42a, Can Replace 42b, Can Add 42c, Can Make Clear Copy 42d.

Application of the “Can View Contents” 42a rule controls whether a file 24 or directory 25 entry can be displayed in the Decrypt or Contents dialogs of the permission wrapper 22. Application of the “Can Add” 42c rule controls whether additional files 24a and directories 25a can be added to the permission wrapper 22. It can be applied to the wrapper as a whole (“Can add to archive”) or to individual directories 25 and files 24 (“Can Write”). Application of the “Can Replace” 42b rule controls whether existing files 24 or directories 25 can be replaced within a permission wrapper 22. This rule can be applied to the permission wrapper 22 as a whole (“Can replace in wrapper”) or to individual directories 25 and files 24 (“Can overwrite”). Application of the “Can Make Clear Copy” 42d rule controls whether files 24 and directories 25 can be decrypted and clear copies of the files placed outside the permission wrapper 22. It can be applied to the permission wrapper 22 as a whole (Allow Decrypt and Open vs. View read-only) or to individual directories 25 and files 24 (“Can Decrypt/Open”).

Content Access Control 42 rules become important as they are explicitly set by the author 26 of the sensitive digital information and are enforced in the Review and Collaboration and Publication phases, 14 and 16 respectively, for sensitive information. The internal system logic of the permission wrapper 22 understands that dynamic application and changes to the Content Access Control 42 rules corresponds to information that is in the Review and Collaboration Phase 14, and Publication Phase 16 of the information lifecycle.

A third set of rules—Administrative Access Control 44—as shown in FIG. 2 relate to the ability of a user 26 to grant access to third party users 27 to the permission wrapped information 23. Administrative Access Control 44 rules include: Can Add User 44a, Can Modify User 44b, Can Modify Expiration 44c, Can Extend User Permission 44d and Can Extend Expiration Permission 44e. Administrative Access Control 44 rules correspond to the Reference Phase 18 of the information lifecycle. Additional users 27 are referring to the permission wrapped digital information 23. They are not changing or modifying the content 23, additional downstream users 27a, 27b, 27c, . . . are merely being granted overall access to the content 23 by other authorized users 26a, 26b, 26c . . . .

Included within the permission wrapper 22 is a file index table 34 of all directories 25 and files 24 contained therein, as shown in FIG. 2, with the file name and the timestamp of when the information was added to the permission wrapper 22. Subsequent changes to the information, such as updating and saving the information back to the permission wrapper 22 are also recorded in this table 34. Since the permission wrapper 22 contains this file index table 34, it has a comprehensive understanding of all content 23 in the permission wrapper 22, the dates created, and which versions are the most current versus older versions. Since the permission wrapper 22 tracks explicit user operations including file opens, reads, writes, deletes and modifies, and uniquely timestamps each operation and records the information in the file index table 34, the internal system logic understands the status of all protected content 23. Embedded system logic uses the file index table 34 to track how recent information 23 has been opened and modified, as well as the frequency of these operations.

The internal system logic of the permission wrapper 22 joins the information contained in the data information table 34 with all of the access control tables—the three discrete sets of permission rules—Wrapper Access Control 40, Content Access Control 42 and Administrative Access Control 44. As the information is joined, the permission wrapper system logic relates information in the file index table 34, such as frequency of access and the most recent timestamp, to the Access Control records. It is from the combination of these two sets of information that the permission wrapper 22 automatically understands the stage of the information lifecycle for information 23 protected in the permission wrapper 22.

A third table is embedded in the permission wrapper 22 which relates to the rules by which the information should be protected at each stage of the information lifecycle as shown in FIG. 1. For each combination of the data information table 34, and the access control rules, a corresponding internal data lifecycle flag is set in the system that defines the stage of the information lifecycle—Creation 10, Electronic Distribution 12, Review and Collaboration 14, Publication 16, Reference 18 and Archival 20. If a change occurs in any of the access control rules—the Administrative User 26 adds users 27a, 27b, 27c, . . . and sets their permissions prior to a sharing operation—the system does a lookup on the file index table 34 to determine if the information has been changed. If the file has been changed, the data lifecycle flag is changed to reflect a new status of Review and Collaboration 14. Correspondingly, if the file has not been changed, as determined by no edit operations in the file index table 34, but extended users 27 have been added to the permission wrapper 22, the data lifecycle flag automatically understands that the information 23 in the permission wrapper 22 is in the Reference Phase 18. Finally, if no users 27 have been added to the permission wrapper 22, no sharing operations have occurred, and no edits or modifications have been made to the information 23 after a specified period of time, the permission wrapper 22 understands that the protected information is in the Archival Phase 20.

The data lifecycle flag contained in the default permission templates 76 identifies the stage of the information lifecycle for the contents 23 contained in the permission wrapper 22. The data lifecycle flag is set in the aggregate—for all files 24 and directories 25 in the permission wrapper 22—and can also be uniquely set to correspond to individual folders 25 and files 24 in the permission wrapper 22. If a permission wrapper 22 contains multiple data items, each set of data (files and/or directories) can be uniquely identified and flagged with the stage of information lifecycle. This is possible since the access control rules can be uniquely described at an individual file/folder level, and a file index table record 34 is associated with each and every file 24 and directory 25 in the permission wrapper 22.

Corresponding with each data lifecycle flag is a separate table in the permission wrapper 22 that shows the default rules for digital rights management of information associated with each stage of the information lifecycle. This table, shown in FIG. 2, consists of a permission template, which consists of an aggregated set of digital rights permission settings (e.g. no copy, no share, can view, lock to PC, etc.) for protected data in various combinations based on user trust levels and data access rules at different stages of the information lifecycle. This table defines the default expected protection settings for data at each stage of the information lifecycle. This table may be overridden or modified based on the explicit rights of the user of the information. As an example, the Administrator, or owner of the information may be able to change these permission templates. Or, the Administrator may not, if a superior set of rules has been established by a higher level Administrator that says changes are not allowed to be made to the default permission templates.

An audit trace log 80 is maintained in the permission wrapper 22 to provide a log file list of all changes in permission settings and the three different main Access Control Rules (Wrapper 40, Content 42 and Administrative 44). The audit trace log 80 provides information on the protected files 24 and directories 25 in the permission wrapper 22, user operations on protected files, requested changes to permission template settings, user add/modify/delete operations, and all sharing operations. The audit trace log 80 also maintains information on subordinate permission wrapper 22″ creation during sharing operations and the unique identifiers associated with these “child” wrappers 22″ that are created from the main, or “parent” permission wrappers 22.

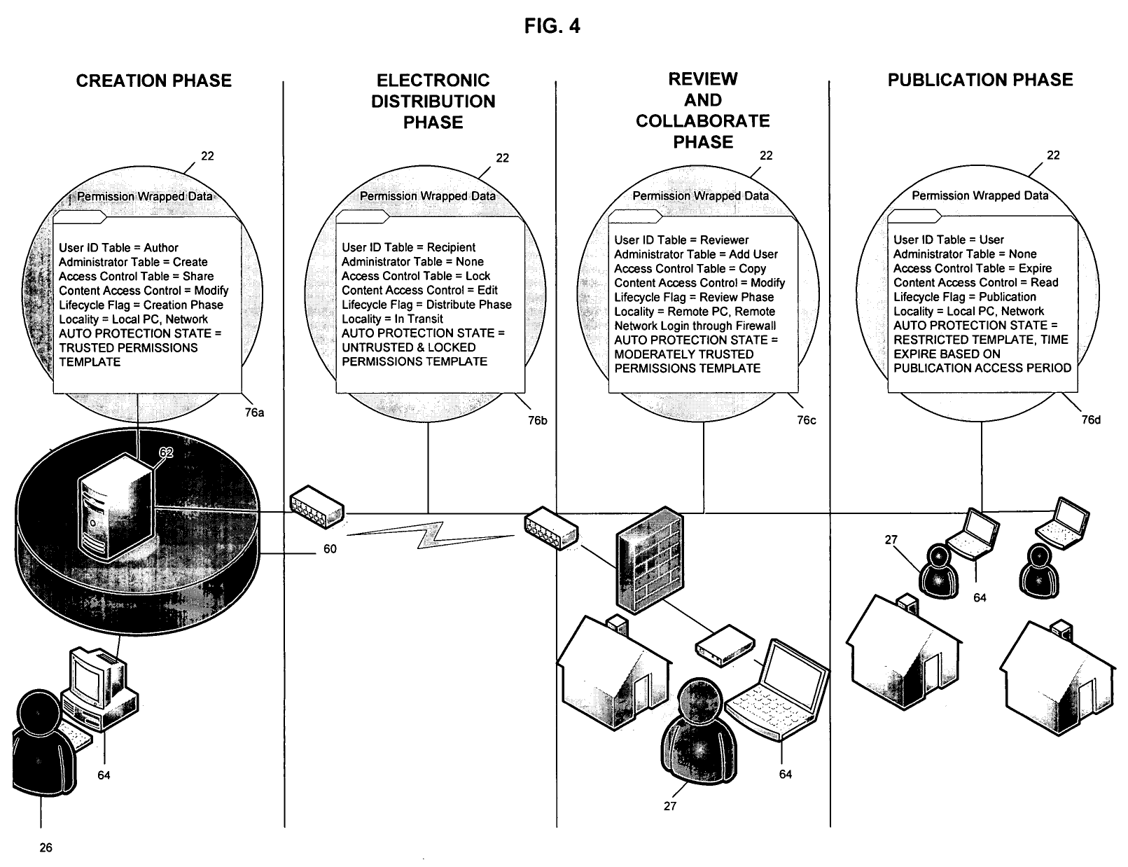

The audit trace log 80 is periodically transmitted over a secure HTTP protocol to a Security Server 62 that maintains a database directory 66 of all permission wrapped data, the information contained therein 23, the users 26 and 27, access types, default permission settings 76a, 76b, 76c, and the stage 10, 12, 14, 16, 18 and 20 of the information lifecycle as set by the data lifecycle flag, see FIG. 4. The periodic basis of the audit trail information transmission is as set by the organization, the systems administrator that controls the security server 62, or by the author 26 of the protected information 23.

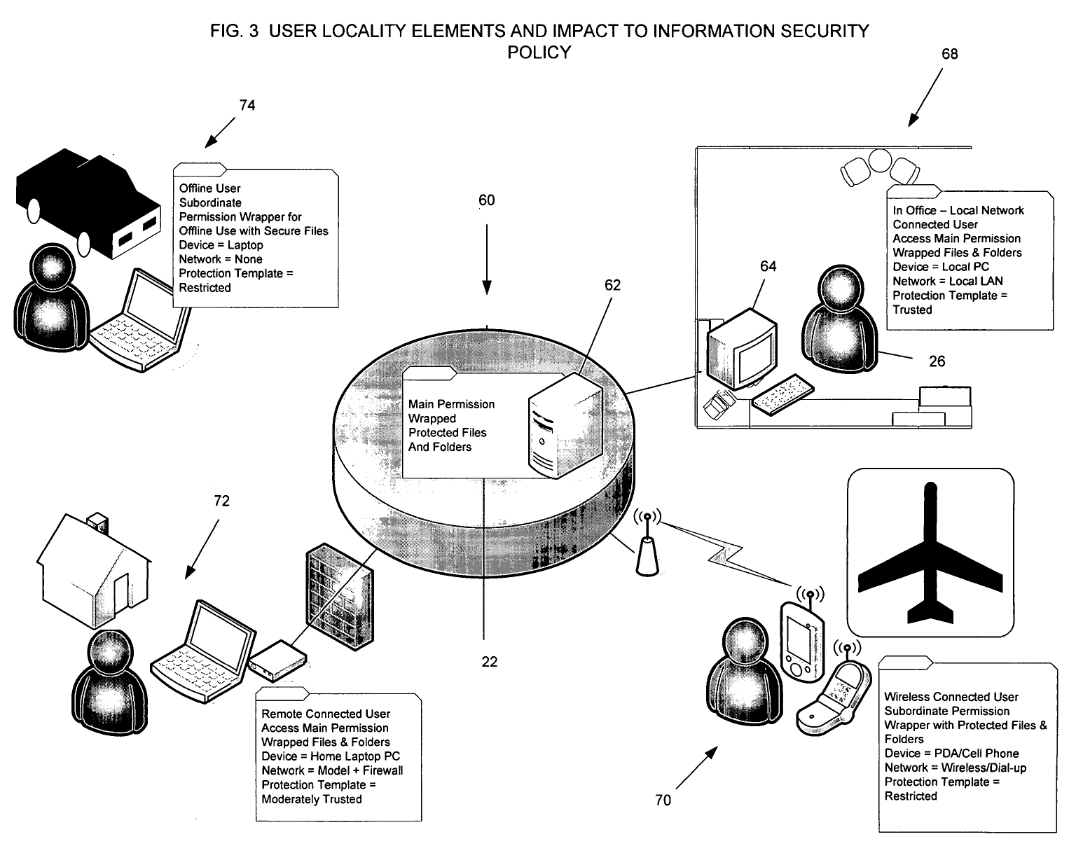

In order to communicate with the Security Server 62, the communication protocol embedded in the permission wrapper 22 periodically pings the network card on the host PC 64 to determine if network access is available or not. The pinging mechanism discriminates as to whether or not the user 26 or 27 is locally connected 68 to the network 60, remotely connected 70 and 72 (e.g. through a dial up connection), or disconnected 74. The pinging mechanism becomes integral in the security scheme for the permission wrapper 22, providing the application with additional information regarding user locality, as shown in FIG. 3. Network pings provide specific information on not only the type of network connection, if present, but the domain/sub-domain structure of the network and its physical location.

Changes in network status and the physical location of the user when associated with the network 60 are reported to the permission wrapper 22 as shown in FIG. 3. Internal logic of the permission wrapper 22 compares the network status/locality of the user to the data lifecycle flag which is contained in the default permission templates, and makes a determination as to whether the combination of the user locality 68, 70, 72 or 74 and lifecycle flag is an allowable event. If it is an allowable event, then the user 26 is granted permission to access the content 23 in the permission wrapper 22 in accordance with his/her Wrapper 40, Content 42 and Administrative 44 rights described in the system tables. If the combination is disallowed then either the user access may be revoked in its entirety, or the user access may be restricted using a number of default automatic protection states for the permission wrapper.

Since the permission wrapper 22 has default permission templates 76a, 76b, 76c, 76d, that correspond to the combination of the user rights and the stage of the information lifecycle, the default permission templates 76 can be automatically enforced by the permission wrapper 22 if a change in information lifecycle stage or user locality occurs. The actions taken by the permission wrapper 22 in recognition of these changes in user locality and stage of information lifecycle consist of a series of default and automatic protection states as shown in FIG. 4. These states can be invoked dynamically by the permission wrapper 22 itself, based on internal logic that recognizes that a change has occurred and the application of a different automatic protection state is required. Automatic protection state changes can also be transmitted externally from the Security Server 60 to any permission wrapped data 23 through the secure communication protocol.

Protection state changes can either increase or lessen the security settings in the permission wrapper 22—based on the combination of the data lifecycle flag, the user locality 68, 70, 72 or 74, the user rights to access the data based on the three access control rule sets (Wrapper 40, Content 42 and Administrative 44). A unique element of the invention is thereby how the permission wrapper 22 recognizes the stage of the information lifecycle 10, 12, 14, 16 18, 20, the user locality 68, 70, 72, 74, the user access control rules 40, 42, 44 and can dynamically and automatically vary the protection states without administrative intervention. Administrative intervention is also accommodated through the communication protocol whereby permission state changes can be pushed to permission wrapped data 23. An example of this is to revoke user 27 access to sensitive permission wrapped content prior to a layoff.

A second major aspect of the invention is shown in FIG. 5. This depicts how the audit trace log 80, when communicated to the Security Server 62, contains unique information regarding sensitive data locations, stage of information lifecycle, users, files and sharing operations. This unique information is compiled from the database 66 on the Security Server 62 into graphical reports that provide color coded reference maps. These reference maps provide a visual reference regarding the physical locations of data, the primary transmission and sharing methods, the user/groups that access the information and over which network connections, and the stage of information lifecycle for major groupings of data (e.g. finance, marketing, business planning, engineering, etc.). This unique aspect of the invention is enabled because the permission wrapper 22 has the ability to report not only contents 23 and user access information, but also data lifecycle information and user locality.

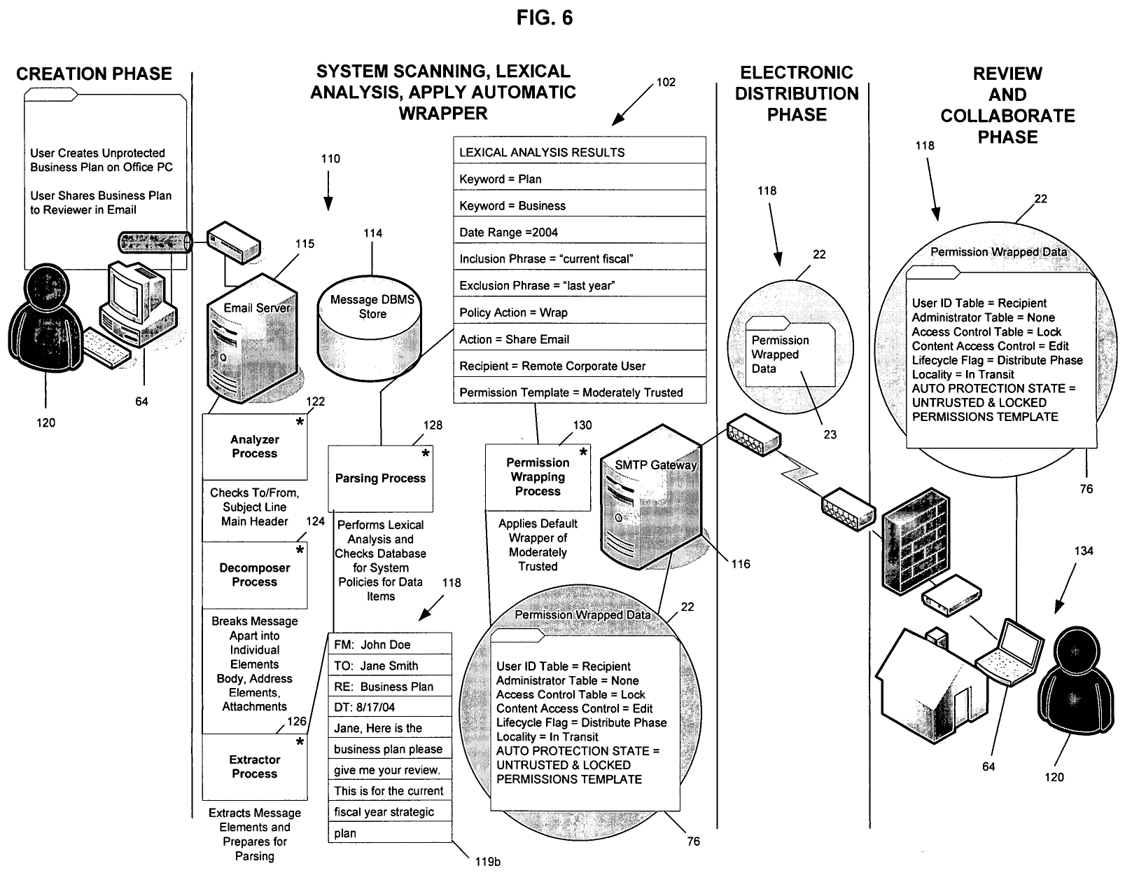

A third major aspect of the invention builds upon the unique security capabilities of the permission wrapper 22 by adding a software scanning process 100 that parses digital information using lexical 102 and abstract document signature analysis 104; automatically finding sensitive digital information. This is shown in FIG. 6.

FIG. 6 shows additional information about the present invention which comprises a computerized system 110 for automatically finding sensitive information using a parsing engine 112 and lexical analysis 114 that identifies the type of information and the associated protection policy and action to take with the information.

The present invention includes a software application that is co-located in the Simple Mail Transfer Protocol (SMTP) email gateway 116, which is the predominate method through which email 118 is shared between corporate users 120. The SMTP gateway 116 co-located software application is executed in-line with the email flow and can be viewed as both the transfer mechanism for email and the policy application for determining how email and file attachments should be protected. The embodiments of the present invention include various software processes including an Analyzer process 122, a Decomposer process 124, an Extractor process 126, a Parsing Engine process 128, a permission wrapping and encryption process 130, an Identity Management and Authentication process 132, and a Viewing/Rendering process 134. These processes are extensible and can be applied in locations other than the email flow. The software processes, inclusive of the Analyzer 122, Decomposer 124, Extractor 126 and Parsing 128 components can be applied to data stored on storage devices, PC and file system hard drives 136.

End-users 120a and 120b predominately transfer files and content to each other via e-mail 118 through email servers 115. The messages flow from the end-user email clients 120a, 120b, 120c, . . . through an SMTP Gateway 116. The Analyzer process 122 is co-located in the email transmission flow. The Analyzer process 122 opens the emails 118 and analyzes the message header information and makes a determination as to whether or not the message should be under security management.

As shown in FIG. 6, the Analyzer process 122 uses a Decomposer process 124, which breaks apart the email 118 into individual components and indexes the meta-data associated with the message. Meta data information retained includes: originating email domain 118a, destination email domain 118b, from email address 118c, to email address 118d and subject information 118e.

As email messages 118 are analyzed and decomposed into their respective segments 119: headers 119a, body text 119b and attachments 119c, each of the various components of the message are indexed, stored in an email storage wrapper and updated into a database. The message information is queued for content evaluation and then sent to an Extractor process 126 and parsed.

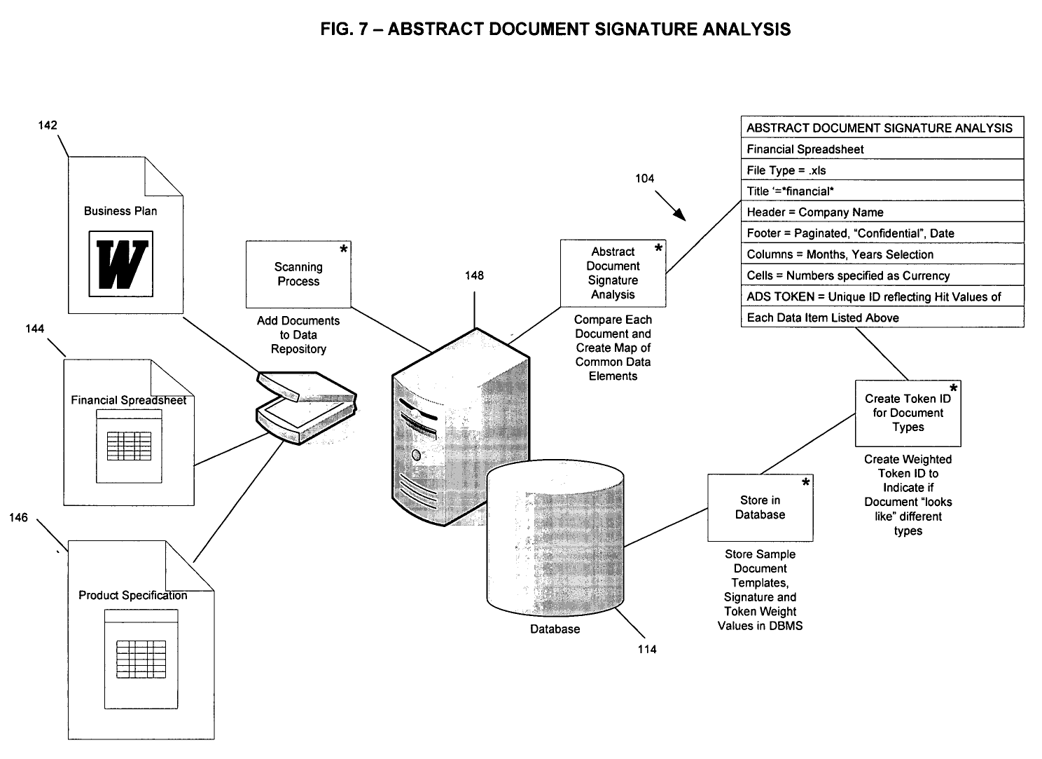

In the Extractor process 126, as depicted in FIG. 7, email text 119b is extracted from any associated email attachments 119c sent along with the email message 118 and is then scanned by the Parsing Process 128. The Parsing Engine 128 is the component that actually reads the content of messages, and using lexical analysis compares it with the rules established by the organization and triggers the actions that are taken with respect to the rules that matched the content 119b.

The Parsing Process 128 evaluates content 119b using lexical analysis 102 and abstract document signature analysis 104 in comparison with any relevant corporate policies and rules that have been previously established for email message information and domiciled in the database 114. When the parsing process 128 starts, it loads into its memory space all the rules, policies and associated user groups that are contained in the database 114.

Policies and rules may be applied separately and in combination and include: block message, quarantine message, route to reviewer, return to sender, attach pre-scripted message (disclaimers), encrypt and protect message, and encapsulate message in the portable software permission wrapper with pre-defined recipient digital rights.

Policies are constructed and stored in the database 114 that specify what security options should be in effect for content that corresponds with rules that are related to the policies. The Parsing Process 128 compares the content of the message with the rules and subsequently links them to the policies

In the present invention, the Parsing Process 128 uses lexical analysis and alternatively abstract document signatures to determine if the email message and attachments meet policy criteria and if the message and attachments should be under active security management. Email messages 118 not under security management flow back to the SMTP Gateway 116 where they are delivered to their intended recipients 120. Email messages 118 under management are queued and stored for further processing.

Lexical analysis 102 evaluates individual keywords, sentences, inclusion phrases and exclusion phrases to determine if a security management policy applies to the email 118 and its attachments. The lexicon is a pre-defined index of words and phrases to search for. Typically the lexicon is defined and is stored in a database 114, and then the index is loaded into memory when searching for sensitive content. FIG. 7 shows how lexical analysis is performed against an email 118 and the associated file attachment. The parsing process 128 looks for keywords, determines if an inclusion or exclusion phrase applies to the context of the sentence or word, and then does a lookup to determine if a match corresponds to a predetermined system action, such as block, quarantine, permission wrap, and default permission wrapping systems.

The first step in establishing the lexicon is to define the keywords, phrases, similes and associations that will be used in searching for sensitive information. This data is defined as text descriptions in search criteria. The search criteria are individually pre-populated into a relational database with each search criteria consisting of a single row in the database. Associated with each keyword, phrase, simile and association may be singular, or multiple rules. These rules define the information security policies to be enforced by the system when the search criteria are found by the context scanner.

Search criteria can be logically grouped into information security policy relationships with common actions to take whenever the search criteria are found. For example, a single information security policy for “Sexual Harassment” may contain numerous search criteria of keywords and phrases to look for. These phrases all relate to the logical grouping of Sexual Harassment, which is defined as a table in the database. Associated with this table are the keywords or phrases to search for and the actions and policies that the system will take when keywords are encountered. The combination of the information security policy grouping and the keyword or phrase encountered determines the system action.

It is the combination of a keyword or phrase, associated with the usage context, and the information security policy grouping that determines the rules or actions to take to protect, block or quarantine that information. These rules are understood to be “policies” associated with data protection. The policies are then enforced through a number of pre-defined system actions.

The lexicon is populated and a lexicon index is loaded into system memory. The context scanning software runs as a real time process in the email gateway or on the network and sifts through all information flowing being transmitted.

The context scanning software invokes the lexicon when Analyzing transmitted information. If a keyword or phrase is encountered that matches the lexicon, a call is made to the database to determine if an information security policy grouping is associated with that keyword or phrase. If a match is found, a subsequent call to the actions table is made and the result if fetched with the result to apply a security permission wrapper, using a default security permission template based on the determination of what type of information has been found.

Abstract Document Signature analysis 104 may be optionally performed in advance of Lexical Analysis 102 for email file attachments. This process is shown in FIG. 7. The Abstract Document Signature engine has predefined templates 140 that have been populated to categorize types of digital information, such as, plans 142, financial spreadsheets 144, product specifications, 146 etc. A series of unique tokens are defined to identify common document elements that are related to document types, such as an account statement always has a 7 digit account number located in the upper right hand corner of the document. Using these document types, and their associated tokens, the Abstract Document Signature engine 104 can rapidly scan individual files 1 19c attached to email messages 118 or stored on file systems 148, to determine if they match a known file type that requires protection. If the file is a match, then the system takes action based on the policy settings in the database.

If the file does not match, the file is optionally submitted to the lexical analysis engine 102 for a detailed analysis of the text strings and data elements in the document. If a match is found that corresponds to an inclusion phrase, the system looks up the policy in the database and can apply to appropriate default security permission wrapper. Alternatively, it can block or quarantine the information from being transmitted.

By the time a message reaches the processing relating to the parameters of an action stemming from lexical analysis, the Parsing Process 128 has already determined that there were insufficient security parameters related to the email message 118 or the file attachment 119c as it was transmitted. As long as there are no other policies (non-security related) that are in effect for the message, it will be wrapped in a permission wrapper 22 according the security parameters or templates 76 specified by the policy and routed to the intended recipients 120 with no more interactions with the end user required.

If on the other hand, the message has been found to contain content 23 that is corresponding to policies that require further processing (i.e. must be presented to a reviewer and approved prior to being sent out) an entry is made to the Security Wrapper Pending table. The System Administrator must then invoke methods of the security wrapper object prior to releasing messages to be routed to the intended recipients.

Throughout this processing the Analyzer software application 122 is logging the events in a security policy audit table 80 as they occur. The security policy audit includes a record of the occurrence of policy controlled content having been encountered, when it was encountered, who sent the message, who was intended to receive the message and whether or not it was secured at the time of presentment for transfer.

A fourth major aspect of the invention is that the permission wrapper 22 maintains all files previously stored in it, unless previously marked for deletion as a version control mechanism. Since the permission wrapper 22 maintains a complete file history, the file index is updated with all current and prior versions of the file stored in the permission wrapper 22. The file index information is also transmitted in the audit trace log 80 to the security server 62. The Analyzer software 122, when encountering a proactively wrapped message by a sender, has the ability to pull file index information, other audit trail information and recognize the unique identifier of the wrapper. This information is subsequently reported to the Security Server to update the master index of all the permission wrapped content shared inside and outside of the organization.

Using the file index information in conjunction with the audit trail information reported on a periodic basis to the Security Server, and the Analyzer process that looks for the same information in email transmissions, the Security Server has a comprehensive understanding of all files in permission wrappers, shared “child” wrappers with reviewers and collaborators, and the versions of those files shared with those users at different points in the information lifecycle. The Security Server has a complete version history and knows the physical locations and users of all copies of the information during the different stages of the information lifecycle. A key aspect of the invention is that the Security Server Administrator can push a command to all permission wrapped data that contains the same, albeit different versions of the digital information, to synchronize and update their permission wrappers with only the most current version of the document.

The permission wrapper upon receiving the request destroys all older copies of the digital information and is automatically updated by the Security Server with the newest version of the sensitive content. A unique record is added in the file index to show that a version control event has occurred and the wrapped content has been synchronized with other wrapped content containing the same information with other users.

The final aspect of the invention is that the permission wrapper provides a portable user interface that is used to open and manipulate content stored in the wrapper. The user interface includes menu and button operations that allow users to view content in the wrapper, search it, organize the content, add new encrypted content, add users, perform sharing operations and set and modify user permissions. A user interface feature bit mask is employed that allows or disallows user interface commands based on the combination of the user permissions defined in the access control table. The feature bit mask also corresponds to a software licensing key, which further determines the operations the user may perform with the data based on their usage license—such as share with others in “child” permission wrappers.

While the invention has been described with respect to a limited number of embodiments, it will be appreciated that many variations, modifications and other applications of the invention may be made.

We claim:

1. A computerized system for protect sensitive data comprising of:
(a) information lifecycle analysis, so that the stage of the information lifecycle is understood to impact the information security protection requirements for digital information;
(b) software for automatically scanning, finding and categorizing sensitive information and determining the stage of the information lifecycle based on criteria such as date of information, frequency of access, users and roles, data location, and document/data types;
(c) software that uses that the stage of the information lifecycle to automatically create and enforce digital rights management controls for sensitive information, that relate to either more or less stringent data protection requirements based on the stage of the information lifecycle; and
(d) a digital permission wrapper that is used to encapsulate digital information enforcing continuous protections over the data wherever the data is stored, however used, and whenever transmitted.

2. The system of claim 1 wherein the permission wrapper recognizes the stage of the information lifecycle and can automatically invoke default permission settings that can be dynamically adapted based on embedded logic that understands that the data is moving from one stage of the lifecycle to the next.

3. The system of claim 1 wherein the permission wrapper understands user locality based on an embedded communication protocol that periodically determines the network status of the user, and as user locality changes, the automatic protection states for the sensitive digital information can be automatically varied to correspond to perceived risks/threats with different physical user environments.

4. The system of claim 1 wherein the permission wrapper associates users with different groups and roles based on their corresponding role in the information lifecycle and associated default permission settings based on the user role.

5. The system of claim 1 further including audit trail information collected in the permission wrapper and periodically transmitted to a central server to provided aggregated information on all protected content, user group/role, sharing operations, file operations, stage of information lifecycle, and unique identifiers that identify parent/child wrappers resulting from sharing operations.

6. The system of claim 1 further including a unique combination of access control roles that define user permissions in the aggregate for wrapped content, in the discriminate for individual files and folders that are protected in the wrapper, and in the administrative for sharing and extending permission to other users.

7. The system of claim 6 wherein the access control rules determine user access for offline access to sensitive digital information based on an embedded communication protocol that has predefined rules that describe how often users must communicate and transmit audit trail information to the central server.

8. The system of claim 1 wherein dynamic digital rights permission changes can be pushed to permission wrapped data through a secure communication protocol in recognition of change in user or information status.

9. The system of claim 1 wherein the software for determining the lifecycle stage of the information includes the ability to transparently and automatically change the security settings based on recognition of information lifecycle changes and actions taken with respect to the sensitive information that correspond to security settings.

10. The system of claim 1 wherein the software determining the stage of the information lifecycle has the ability to understand multiple versions and copies of information exist, and the ability to coordinate versions and synchronize permission wrapped information across many distributed users, using a unique identifier tag, and file index information maintained in the permission wrapper.

11. A system for protecting sensitive information comprising:
(a) software for automatically scanning, finding and categorizing sensitive information and analyzing, decomposing and extracting digital information shared in the email flow; and
(b) a digital permission wrapper that is used to encapsulate the sensitive digital information enforcing continuous protections over the data wherever the data is stored, however used, and whenever transmitted.

12. The system of claim 11 further including a lexical analysis process and abstract document signature categorization and token based analysis for locating the sensitive information.

13. The system of claim 11 wherein the permission wrapper is automatically applied to the sensitive information being transmitted to other users using the automated software processes that scan all information in the email gateway.

14. The system of claim 13 wherein the system has the ability to take other system actions such as block, quarantine, or hold for administrative review prior to applying a permission wrapper.

15. The system of claim 11 further including an analyzer process to unwrap a proactively wrapped email message, and determine if the wrapped content policy settings match the corporate default settings.

16. The system of claim 11 wherein the permission wrapper controls the access to the sensitive information through a portable user interface that is used to access content contained in the wrapper.

17. The system of claim 16 wherein the usage of the portable user interface features is further constrained by a software license key that allows or disallows user interface features and permission wrapper operations based on the software license for that user or organization.

18. A method for establishing the access to sensitive digital information comprising the step of determining the lifecycle phase of the digital information and setting the access to the sensitive digital information based on said lifecycle phase.

19. The method of claim 18 further including the step of detecting the locality of a user attempting to access the sensitive information.

20. The method of claim 19 wherein the access to the sensitive information varies depending user locality.
